(19) United States
(12) Patent Application Publication
(10) Pub. No.: US 2010/0323268 A1
(43) Pub. Date: Dec. 23, 2010

(54) SYSTEM AND METHOD FOR FORMING CONDUCTORS OF AN ENERGY GENERATING DEVICE

(75) Inventors: Milton B. Hollander, Stamford, CT (US); James J. Ferguson, Mullica Hill, NJ (US)

Correspondence Address: MICHAUD-Kinney Group LLP, 306 INDUSTRIAL PARK ROAD, SUITE 206, MIDDLETOWN, CT, 06457, US

(73) Assignee: White Box, Inc., Stamford, CT (US)

(21) Appl. No.: 12/567,018

(22) Filed: Sep. 25, 2009

Related U.S. Application Data
(60) Provisional application No. 61/218,723, filed on Jun. 19, 2009.

(51) Int. Cl. H01M 8/10; H01B 5/00; H01B 7/00; H01R 43/00; H01M 8/02

(52) U.S. Cl. 429/479; 174/133 R; 174/119 R; 29/825; 429/522

(57) ABSTRACT

An electrical circuit is presented that includes an anode conductor formed from a first wire lead and a cathode conductor formed from a second wire lead. The first wire lead and the second wire lead are each comprised of wire having a predetermined diameter. At least a portion of the predetermined diameter of at least one of the first and the second wire leads is compressed to provide an increased surface area. In one embodiment, the anode and the cathode conductors are disposed about an electrolyte material of an energy generating device, e.g., a fuel cell. The increased surface area of the at least one first and the second leads increases a total collected energy of the fuel cell without increasing the conductor mass or tensile strength such that weight and other characteristics of the fuel cell are not adversely impacted as compared to conventional fuel cell arrangements.

### CROSS-REFERENCE TO RELATED APPLICATIONS

This patent application claims priority benefit under 35 U.S.C. §119(e) of copending, U.S. Provisional Patent Application Ser. No. 61/218,723, filed Jun. 19, 2009, the disclosure of this U.S. patent application is incorporated by reference herein in its entirety.

### BACKGROUND OF THE INVENTION

1. Field of the Invention

The present invention relates generally to fuel cells for powering a process and/or an apparatus and, more particularly, to a system and method for increasing electrical energy collection of fuel cell conductors.

2. Description of Related Art

Energy generating devices such as, for example, fuel cells and catalytic converters, are well known. Generally speaking, a fuel cell generates electricity by combining hydrogen with oxygen. For example, in a solid oxide fuel cell (SOFC) electricity is produced directly from oxidizing a fuel. SOFC devices include a solid oxide, or ceramic, electrolyte. Advantages of this class of fuel cells include high efficiencies, long term stability, fuel flexibility, low emissions, and cost. A perceived disadvantage is that high operating temperature results in longer start up times and mechanical/chemical compatibility issues.

In operation, oxygen is reduced into oxygen ions at a cathode. The oxygen ions then diffuse through the solid oxide electrolyte to an anode where they electrochemically oxidize fuel (e.g., light hydrocarbons such as methane, propane, butane, and the like) in the fuel cell. In the oxidizing reaction water is a typical byproduct as well as two electrons. The electrons then flow through an external circuit as usable electricity. The inventors have recognized that a need exists to improve the collection of electrical energy within fuel cells.

### SUMMARY OF THE INVENTION

The present invention resides in one aspect in an electrical circuit, including an anode conductor formed from a first wire lead and a cathode conductor formed from a second wire lead. In one embodiment, the first wire lead and the second wire lead are each comprised of wire having a predetermined diameter. At least a portion of the predetermined diameter of at least one of the first wire lead and the second wire lead is compressed to provided an increased surface area of the at least portion as compared to a remainder of the predetermined diameter.

In one aspect of the invention, the compressed predetermined diameter maintains a same cross sectional area as the remainder of the predetermined diameter and has an increased surface area. In one embodiment, the increased surface area of the compressed predetermined diameter is at least about two (2) times a surface area of the remainder of the predetermined diameter. In one embodiment, the first and the second wire leads are nickel or nickel-based.

In yet another embodiment, a portion of one or both of the first wire lead and/or the second wire lead is covered by a high temperature, porous, non-conducting insulation. The insulation may be comprised of, for example, at least one of a ceramic insulator, a ceramic-like insulator, and a silicon insulator. In one embodiment, the ceramic-like insulator is comprised of an alumina-boria-silica insulator.

In still another embodiment, the anode conductor and the cathode conductor are disposed about an electrolyte material of the fuel cell. Exemplary electrolyte materials include a solid oxide electrolyte.

In one aspect, the present invention resides in a fuel cell having an anode conductor, a cathode conductor, and an electrolyte material disposed between the anode conductor and the cathode conductor. In one embodiment, a first inlet provides oxygen to the cathode conductor, the oxygen being reduced into oxygen ions, and a second inlet provides a fuel to the anode conductor. The oxygen ions diffuse through the electrolyte material to the anode conductor and electrochemically oxidize the fuel to produce electrons. An external electrical circuit is coupled to the fuel cell and receives the electrons from the anode conductor.

In one embodiment, the anode conductor is formed from a first wire lead and the cathode conductor is formed from a second wire lead. The first wire lead and the second wire lead are each comprised of wire having a predetermined diameter. At least a portion of the predetermined diameter of at least one of the first wire lead and the second wire lead is compressed to provide an increased surface area.

In another embodiment, a portion of one or both of the first wire lead and/or the second wire lead are covered by a high temperature, porous, non-conducting insulation. In still another embodiment, the electrolyte materials are comprised of a solid oxide electrolyte.

### BRIEF DESCRIPTION OF THE DRAWINGS

The foregoing aspects and other features of the presently disclosed embodiments are explained in the following description, taken in connection with the accompanying drawings, wherein:

FIG. 1 is a simplified schematic diagram of a fuel cell having at least one conductor providing improved electrical energy collection capability; and

FIGS. 2A and 2B depict a lead wire having a flattened or compressed portion.

### DESCRIPTION OF PREFERRED EMBODIMENTS OF THE INVENTION

As described herein, the inventors have discovered that electrical energy collection is improved by increasing a surface area of conductors of an external circuit coupled to an energy generating device such as, for example, a fuel cell, a catalytic converter, and like devices. An increase in the surface area of one or more of the conductors increases a total collected energy produced by the energy generating device. The inventors have further discovered that it would be advantageous to provide conductors having increased surface area without increasing a mass of the conductors and without reducing the tensile strength of the conductor or its cross sectional area, so as not to compromise weight and other characteristics of the energy generating device.

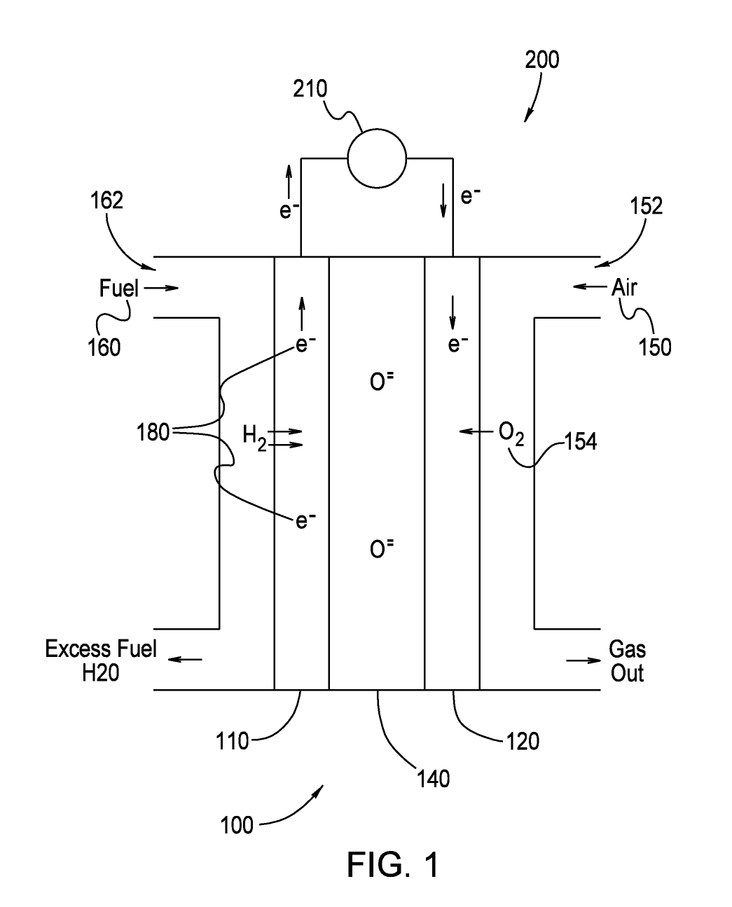

FIG. 1 is a simplified schematic diagram of an energy generating device 100 such as, for example, a solid oxide fuel cell, for producing electricity to power an external electrical circuit 200. The fuel cell 100 includes an anode conductor 110 and a cathode conductor 120 disposed about an electrolyte material 140 such as, for example, a solid oxide or ceramic electrolyte. As is generally known in the art, oxygen 150 (e.g., air) is feed into the fuel cell 100 via an inlet 152 and a fuel 160 such as, for example, a light hydrocarbon, is introduced to the fuel cell 100 via an inlet 162.

As shown in FIG. 1, the oxygen 150 is reduced into oxygen ions (O₂) 154 at the cathode conductor 120. The O₂ 154 diffuses through the electrolyte material 140 to the anode conductor 110 to electrochemically oxidize the fuel 160. In the oxidizing reaction, electrons (e−) 180 are produced. The e− 180 flow from the anode conductor 110 to the cathode conductor 120 through the external electrical circuit 200 as electricity that may be used, for example, to power a process or an apparatus 210 of the external circuit 200.

It should be appreciated that, while the energy generating device 100 is described hereinafter as a fuel cell, it is within the scope of the present disclosure for the energy generating device 100 to be a catalytic converter where a liquid such as, for example, water, undergoes a catalytic reaction for its dissociation into a hydrogen ion and an electron (e.g., e− 180).

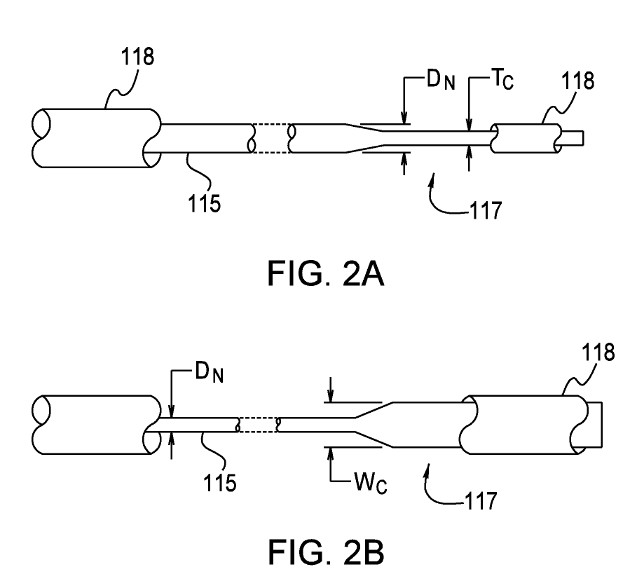

In accordance with the present invention, at least one of the anode conductor 110 and the cathode conductor 120 is comprised of a wire 115 (FIGS. 2A and 2B) such as, for example, a nickel or nickel-based wire. In one embodiment, the nickel-based wire is comprised of a nickel-silicon alloy such as, for example, an alloy sold under the brand name NISIL™ by Omega Engineering, Inc. (Stamford, Conn. USA). In one embodiment, the nickel or nickel-based wire conductor 115 is comprised of a wire having a nominal diameter D_{N} in a range of about 0.010 inch (0.2546 mm) to about 0.250 inch (6.350 mm). It should be noted that a wire of diameter D_{N} of about 0.010 inch (0.2546 mm) to about 0.250 inch (6.350 mm) has a surface area of between about 0.0314 sq. in. per inch (20.26 mm² per mm) of length to about 0.785 sq. in. per inch (506.45 mm² per mm) of length.

In one embodiment, the nickel or nickel-based wire anode conductor 110 collects energy generated by the energy generating device 100 (e.g., the fuel cell), for example, the e− 180. The nickel or nickel-based wire anode conductor 110 is a lead to the external electrical circuit 200 coupling the process or apparatus 210 to the fuel cell 100. In one embodiment, the nickel or nickel-based wire cathode conductor 120 is a lead from the external electrical circuit 200 back to the fuel cell 100. In one aspect of the invention, a portion 117 of the diameter D_{N} of the wire conductors 115, e.g., the anode conductor 110 and/or the cathode conductor 120, is compressed or flattened from a round cross section to increase the surface area by at least about two (2) times. This is accomplished, for example, by flattening or compressing the portion 117 of the wire 115 of about 0.020 inch (0.508 mm) in diameter to about 0.005 inch (0.127 mm). When flattened, the portion 117 of the wire has a width W_{C} of about 0.045 inch (1.143 mm), is ribbon like, and has about the same cross section area (0.0314 square inches, 0.7976 mm) as the original round wire (e.g., the diameter D_{N}), but now the portion 170 has a thickness T_{C} of about 0.005 inch (0.127 mm). It should be appreciated that by compressing or flattening the existing nickel or nickel-based wire conductors 115 of the fuel cell 100 neither the conductor mass or tensile strength is increased so that, for example, the fuel cell 100 increases total collected energy without increasing weight and other characteristics as compared to conventional fuel cell arrangements. It should also be appreciated that the increased surface area improves conductivity of the conductors 115 as well as connectivity (e.g., line contact versus point contact).

In one embodiment, the compressed wire conductor is replaced by a wire ribbon having the same cross sectional area as the compressed wire (e.g., the portion 117 represents an entire length of the wire 115). In one embodiment, one or both of the anode wire conductor 110 and/or the cathode wire conductor 120 is coated with or covered by a high temperature, porous, non-conducting insulation 118 such as, for example, a ceramic, ceramic-like or silicon insulator. In one embodiment, the ceramic-like insulation is an alumina-boria-silica insulation.

The foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the present disclosure and one or more of the appended claims.

What is claimed is:

1. An electrical circuit, comprising:
an anode conductor forming a first wire lead; and
a cathode conductor forming a second wire lead;
wherein the first wire lead and the second wire lead are each comprised of wire having a predetermined diameter, and wherein at least a portion of the predetermined diameter of at least one of the first wire lead and the second wire lead is compressed to provided an increased surface area of the at least portion as compared to a remainder of the predetermined diameter.

2. The electrical circuit of claim 1, wherein the compressed portion of predetermined diameter maintains a same cross sectional area as the remainder of the predetermined diameter and has an increased surface area.

3. The electrical circuit of claim 1, wherein the increased surface area of the compressed predetermined diameter is at least about two (2) times a surface area of the remainder of the predetermined diameter.

4. The electrical circuit of claim 1, wherein at least one of the first wire lead and the second wire lead is comprised of a wire ribbon having a same cross sectional area as the compressed portion of the predetermined diameter.

5. The electrical circuit of claim 1, wherein the first and the second wire leads are nickel or nickel-based.

6. The electrical circuit of claim 1, wherein a portion of one or both of the first wire lead and/or the second wire lead is covered by a high temperature, porous, non-conducting insulation.

7. The electrical circuit of claim 1, wherein the insulation is comprised of at least one of a ceramic insulator, a ceramic-like insulator, and a silicon insulator.

8. The electrical circuit of claim 7, wherein the ceramic-like insulator is comprised of an alumina-boria-silica insulator.

9. The electrical circuit of claim 1, wherein the anode conductor and the cathode conductor are disposed about an electrolyte material of a fuel cell.

10. The electrical circuit of claim 9, wherein the electrolyte materials is comprised of a solid oxide electrolyte.

11. An energy generating device, comprising:
an anode conductor;
a cathode conductor;
an electrolyte material disposed between the anode conductor and the cathode conductor;
a first inlet that provides oxygen to the cathode conductor, the oxygen being reduced into oxygen ions;
a second inlet for providing a fuel to the anode conductor;
wherein the oxygen ions diffuse through the electrolyte material to the anode conductor and electrochemically oxidize the fuel to produce electrons; and
an external electrical circuit coupled to the energy generating device for receiving the electrons from the anode conductor.

12. The energy generating device of claim 11, wherein the anode conductor is formed from a first wire lead and the cathode conductor is formed from a second wire lead, the first wire lead and the second wire lead are each comprised of wire having a predetermined diameter, and wherein at least a portion of the predetermined diameter of at least one of the first wire lead and the second wire lead is compressed to provided an increased surface area.

13. The energy generating device of claim 12, wherein at least one of the first wire lead and the second wire lead is comprised of a wire ribbon having a same cross sectional area as the compressed portion of the predetermined diameter.

14. The energy generating device of claim 11, wherein a portion of one or both of the first wire lead and/or the second wire lead is covered by a high temperature, porous, non-conducting insulation.

15. The energy generating device of claim 11, wherein the electrolyte materials is comprised of a solid oxide electrolyte.

16. A method for forming a conductor of an energy generating device, the method comprising steps of:
providing a first wire having a predetermined diameter and a first surface area;
compressing a portion of the predetermined diameter to form a second surface area being increased as compared to the first surface area; and
coupling the portion of the first wire as a lead conductor of the energy generating device.

17. The method of claim 16, wherein the compressed portion of the predetermined diameter maintains a same cross sectional area as the predetermined diameter.

18. The method of claim 16, wherein the second surface area is at least about two (2) times the first surface area.

19. The method of claim 16 further includes:
compressing a portion of at least a second wire having the predetermined diameter to form the second surface area; and
coupling the portion of the second wire as a lead conductor of the energy generating device;
wherein the first wire lead is an anode conductor and the second wire lead is a cathode conductor.

20. The method of claim 16, wherein the first and the second wire leads are nickel or nickel-based.
